(19) United States
(12) Patent Application Publication
(10) Pub. No.: US 2024/0239228 A1
(43) Pub. Date: Jul. 18, 2024

(54) DETERMINATION DEVICE

(71) Applicant: TOYOTA JIDOSHA KABUSHIKI KAISHA, Toyota-shi (JP)

(72) Inventors: Kenichi YAMADA, Nisshi-shi (JP); Toshiki KASHIWAKURA, Tokyo (JP); Akane UMEZU, Nagoya-shi (JP); kayo TSUMOTO, Nisshi-shi (JP); Yuta SHISHIME, Tokyo (JP); Satoshi KOMAMINE, Nagoya-shi (JP); Kenji ISHIYAMA, Kasugai-shi (JP)

(73) Assignee: TOYOTA JIDOSHA KABUSHIKI KAISHA, Toyota-shi (JP)

(21) Appl. No.: 18/508,918

(22) Filed: Nov. 14, 2023

(30) Foreign Application Priority Data
Jan. 13, 2023 (JP) 2023-004109

(51) Int. Cl. B60L 53/66; B60L 53/30

(52) U.S. Cl. CPC B60L 53/66; B60L 53/305

(57) ABSTRACT

The determination device includes a storage unit, a communication unit, and a control unit. The storage unit can store a plurality of pieces of charging result information including a set of charging place information indicating a charging place included in a request received in the past and charging possibility information indicating whether or not the vehicle has been charged at the charging place. The communication unit can communicate with a user terminal carried by the user, and can receive a request from the user. The control unit retrieves the charging result information based on the charging place information of the vehicle included in the request, acquires the charging possibility information related to the charging place, and determines a possibility of charging at the charging place based on the acquired charging possibility information.

### CROSS-REFERENCE TO RELATED APPLICATION

This application claims priority to Japanese Patent Application No. 2023-004109 filed on Jan. 13, 2023, incorporated herein by reference in its entirety.

### BACKGROUND

### 1. Technical Field

The present disclosure relates to a determination device that determines whether charging by a power supply vehicle is possible.

### 2. Description of Related Art

There is proposed a system in which a charging service provided by a business operator is reserved when a battery charge amount becomes equal to or less than a predetermined value in a vehicle traveling by using electricity as a power source (see, for example, Japanese Unexamined Patent Application Publication No. 2021-121885 (JP 2021-121885 A)). In the service according to the related art, a power supply vehicle of the business operator goes to a location of a vehicle requiring charging, and a worker of the power supply vehicle inserts a charging plug into a charging port of the charging target vehicle to charge a battery. According to the related art, it is possible to cause a third party to charge the battery of the vehicle even while a user is away from the vehicle.

### SUMMARY

Even when the worker of the charging business operator tries to charge the charging target vehicle, the charging may be impossible depending on a surrounding environment of a place where the vehicle is parked. For example, when there is an obstacle such as a wall or a fence in front of the charging port of the charging target vehicle, it may be difficult for the worker to connect a connector of a charging cable of the power supply vehicle to the charging port depending on the distance between the charging port and the obstacle. When the user stops the vehicle in a parking lot of a facility used by many people, the power supply vehicle may be unable to enter the parking lot due to restrictions on the size or the like. Further, the power supply vehicle may be unable to charge the charging target vehicle by stopping nearby due to congestion in the parking lot depending on the day of the week or a time period.

In view of such circumstances, an object of the present disclosure is to reduce an opportunity loss of a power supply vehicle due to the fact that the power supply vehicle cannot charge a charging target vehicle after the power supply vehicle has arrived at the location of the charging target vehicle.

A determination device according to one embodiment of the present disclosure to solve the above problem is a determination device configured to, in a charging service for charging a vehicle of a user by dispatching a power supply vehicle in response to a request from the user, make determination on a possibility of charging the vehicle of the user based on the request. The determination device includes: a storage unit configured to store a plurality of pieces of charging result information including a set of charging place information included in a request received in a past and indicating a charging place and charging possibility information indicating whether a vehicle has been charged at the charging place; a communication unit configured to communicate with a user terminal carried by the user and receive the request from the user; and a control unit configured to search for the charging result information based on charging place information of the vehicle included in the request, acquire the charging possibility information at the charging place, and make determination on the possibility of charging at the charging place based on the acquired charging possibility information.

According to the present disclosure, it is possible to reduce the opportunity loss of the power supply vehicle due to the fact that the power supply vehicle cannot charge the charging target vehicle after the power supply vehicle has arrived at the location of the charging target vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram illustrating a schematic configuration of a system including a determination device according to an embodiment of the present disclosure;

FIG. 2 is a diagram illustrating a schematic configuration of the determination device of FIG. 1 together with an example of charging result information stored in a storage unit;

FIG. 3 is a block diagram illustrating a schematic configuration of the user terminal, the worker terminal, and the in-vehicle device of FIG. 1;

FIG. 4 is a diagram for explaining charging of a vehicle to be charged by a power supply vehicle;

FIG. 5 is a diagram illustrating an exemplary parking lot arrangement in a case where a power supply vehicle can be charged and a case where a power supply vehicle cannot be charged; and

FIG. 6 is a flowchart illustrating an exemplary process in which determination device determines the chargeability of the requested vehicles.

### DETAILED DESCRIPTION OF EMBODIMENTS

Hereinafter, an embodiment of the present disclosure will be described below with reference to the drawings. Note that the drawings used in the following description are schematic. Dimensions, ratios, and the like in the drawings do not necessarily coincide with actual ones.

### Overall Configuration of System

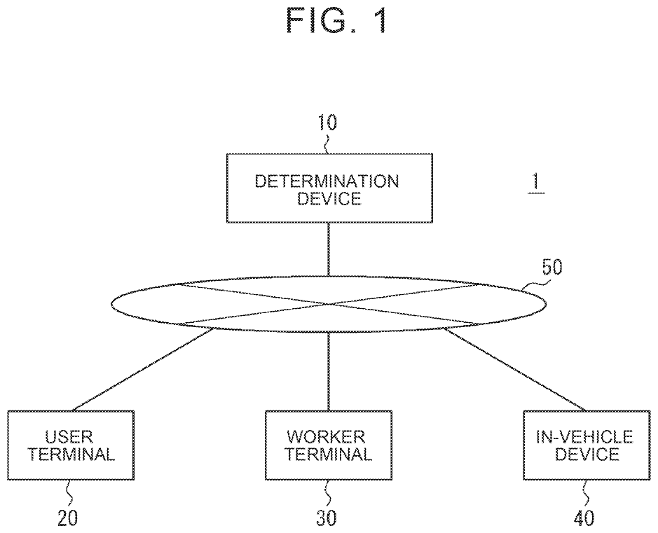

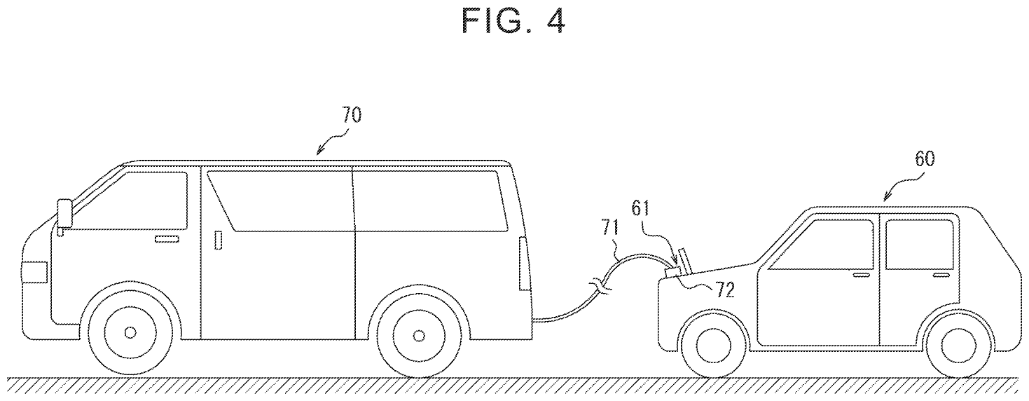

FIG. 1 is a schematic configuration diagram of a system 1 that dispatches a power supply vehicle 70 (see FIG. 4) that provides a charging service to a vehicle 60 (see FIG. 4) of a user in response to a request from the user. The system 1 includes a determination device 10, a user terminal 20, and a worker terminal 30, and a network 50 that connects these components to each other so as to be able to communicate with each other. The system 1 may further include an in-vehicle device 40 provided in the power supply vehicle 70. A plurality of user terminals 20, worker terminals 30, and in-vehicle devices 40 may exist.

The determination device 10 is a computer operated by a provider that provides a charging service. The determination device 10 can receive a request for charging the vehicle 60 from the user terminal 20 carried by the user. The charging request includes a request for immediate charging and a request for reserving charging by specifying a time. The charging request includes charging place information indicating a place where the vehicle to be charged is to be charged. Upon receiving a charging request from the user, the determination device 10 acquires charging possibility information indicating whether charging has been performed at the same charging place in the past, and determines a possibility of charging at the charging place based on the charging possibility information. The processing performed by the determination device 10 may be executed in a distributed manner on a plurality of computers.

The user terminal 20 is an information processing device such as a Personal Computer (PC carried by a user), a smart phone, and a portable information terminal. When the charging service is provided as the membership service, the user uses the user terminal 20 to register information of the vehicle 60 with the determination device 10 in advance. The information of the vehicle 60 to be registered includes identification information of the vehicle 60, information for communicating with the vehicle 60, and the like. The identification information of the vehicle 60 includes information such as a registration number, a vehicle type, and a color of the vehicle. The information for communicating with the vehicle 60 includes, for example, a communication address of the vehicle 60. The user can request the determination device 10 to charge the vehicle 60 using the user terminal 20. The request for charging the determination device 10 may include identification information of the user, a place where charging is desired, a date and time, identification information of the vehicle 60, and the like.

The worker terminal 30 is a mobile information terminal such as a smartphone carried by a worker of an operator providing a charging service. The worker terminal 30 can receive the schedule information for charging using the power supply vehicle 70 from the determination device 10. The schedule information received by the worker terminal 30 includes time, place, identification information of the vehicle 60, and the like at which one or more vehicles 60 are charged. Further, the worker goes to the charging place of the vehicle 60 to be charged, and inputs the work result of charging to the worker terminal 30. The operator inputs information indicating whether charging has been performed or not. When charging is possible, the worker may input the time taken from when the power supply vehicle 70 arrives at the location of the vehicle 60 to when the charging of the vehicle 60 is started, and/or the time from when the power supply vehicle 70 completes the charging of the vehicle 60 to when the vehicle 60 leaves the location. A dedicated application is mounted on the worker terminal 30, and it is possible to support or automate the input by the worker. The information input by the operator is transmitted to the determination device 10.

The in-vehicle device 40 is an information processing device mounted on the power supply vehicle 70. The in-vehicle device 40 is mounted on the power supply vehicle 70 and can perform various information processing. Instead of the worker terminal 30, the operator may receive information from the determination device 10 using the in-vehicle device 40 and transmit information to the determination device 10. When the worker terminal 30 is present, the in-vehicle device 40 is not an essential component.

The network 50 includes a wide area network such as the Internet. The determination device 10, the user terminal 20, the worker terminal 30, and the in-vehicle device 40 are connected to a wide area network via an access line. Access lines may include, but are not limited to, a fourth generation mobile communication system (4G), such as a third generation mobile communication system (3G), Long Term Evolution (LTE), a fifth generation mobile communication system (5G), Wi-Fi, and Worldwide Interoperability for Microwave Access (WiMAX).

### Configuration of Determination Device

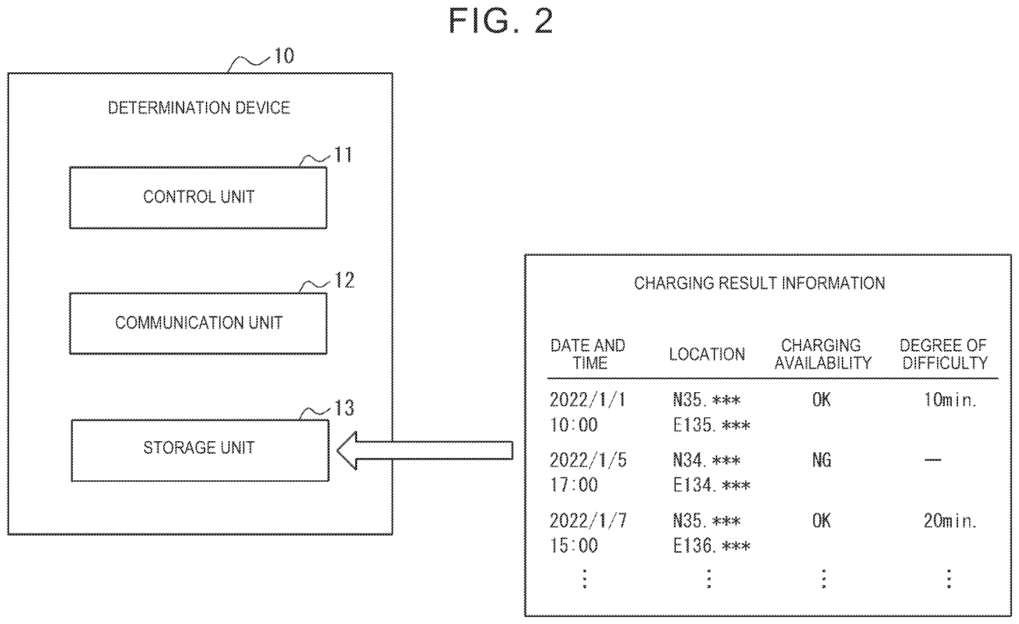

As illustrated in FIG. 2, the determination device 10 includes a control unit 11, a communication unit 12, and a storage unit 13.

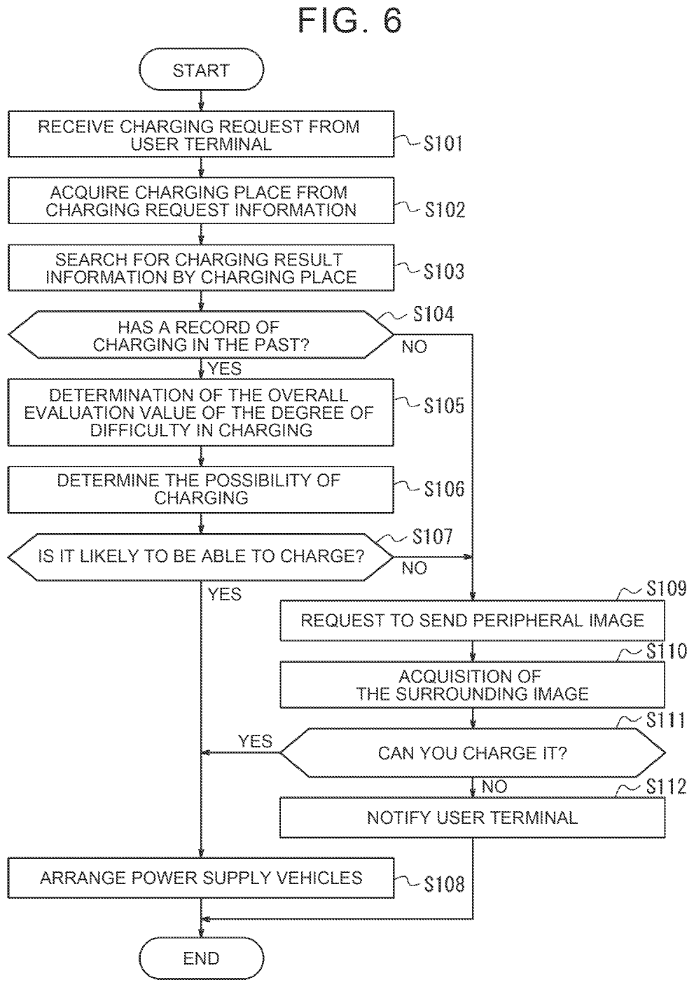

The control unit 11 includes at least one processor, at least one dedicated circuit, or a combination thereof. A processor may be a general-purpose processor, such as a Central Processing Unit (CPU), or a special-purpose processor specialized for a particular process. The control unit 11 executes processing related to the operation of the determination device 10 while controlling each unit of the determination device 10. Hereinafter, the processing executed by the control unit 11 may be described as being executed by the determination device 10. The control unit 11 executes processing of the determination device 10 described in the flow diagram of FIG. 6, which will be described later, according to the program.

The communication unit 12 includes at least one external communication interface connected to the network 50. The external communication interface may be either a wired communication or a wireless communication interface. The communication unit 12 receives information for processing by the determination device 10 from the outside (the user terminal 20, the worker terminal 30, the in-vehicle device 40, and the like), and transmits information obtained as a result of the processing by the determination device 10 to the outside.

The storage unit 13 includes at least one semiconductor memory, at least one magnetic memory, at least one optical memory, or a combination of at least two types thereof. The storage unit 13 functions as, for example, a main storage device, an auxiliary storage device, or a cache memory. The storage unit 13 stores programs and data used for the operation of the determination device 10 and data obtained by the operation of the determination device 10. The information stored in the storage unit 13 may be updatable by, for example, information acquired from the network 50 via the communication unit 12.

The storage unit 13 may store information of the registered user who receives the charging service and the vehicle 60 held by the user. The information may include information such as identification information of the user, a storage location (parking lot) of the vehicle 60, identification information of the vehicle 60, and the like. The storage location of the vehicle 60 may be registered as a charging place for receiving a charging service in advance.

The storage unit 13 may further store a plurality of charging result information including a set of charging place information indicating a charging place included in a charging request received in the past and charging possibility information indicating whether or not the vehicle 60 has been charged at the charging place. Further, the charging result information may include information such as the date and time and/or day of the week when the charging is performed, and information on the degree of difficulty. An example of charging result information is shown in FIG. 2.

The charging place may be expressed by, for example, latitude and longitude, but is not limited thereto. The charging place may be described by an address or the like. The degree of difficulty indicates a degree of difficulty in charging the vehicle 60. The degree of difficulty may be, for example, the time it takes for the power supply vehicle 70 to arrive at the location of the vehicle 60 before starting the charging of the vehicle 60 and/or the time it takes for the power supply vehicle 70 to complete the charging of the vehicle 60 before leaving the location of the vehicle 60. For example, it is presumed that the long time it takes for the power supply vehicle 70 to start charging the vehicle 60 after arriving at the location of the vehicle 60 is due to the fact that it takes time and effort to connect the charging cable 71 of the power supply vehicle 70 to the charging port 61 of the vehicle 60. The difficulty level may be an index of these times. The control unit 11 can search for charging result information by specifying a charging place.

Note that the determination device 10 of the present embodiment may further include an input unit and an output unit. That is, in addition to receiving (inputting) and transmitting (outputting) information via the communication unit 12, the determination device 10 may input and output information via the input unit and the output unit.

### User Terminal/Worker Terminal/In-Vehicle Device

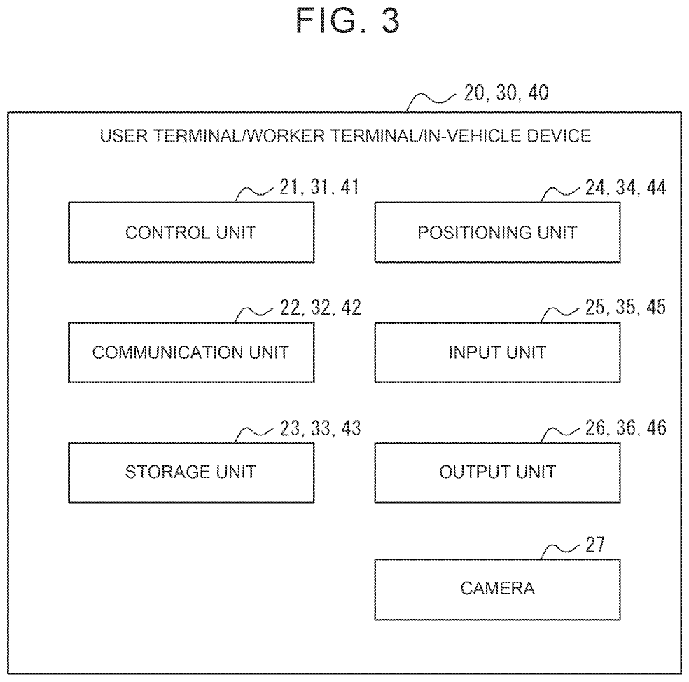

As illustrated in FIG. 3, the user terminal 20, the worker terminal 30, and the in-vehicle device 40 include control units 21, 31, and 41, communication units 22, 32, and 42, storage units 23, 33, and 43, positioning units 24, 34, and 44, input units 25, 35, and 45, and output units 26, 36, and 46, respectively. The components of the in-vehicle device 40 may be distributed and arranged in the vehicle 60. Since the user terminal 20, the worker terminal 30, and the in-vehicle device 40 are similar in configuration, they will be collectively described below with reference to the same FIG. 3.

The control units 21, 31, and 41 include at least one processor, at least one dedicated circuit, or a combination thereof. The control units 21, 31, and 41 execute processes related to operations of the user terminal 20, the worker terminal 30, and the in-vehicle device 40 while controlling the respective units of the user terminal 20, the worker terminal 30, and the in-vehicle device 40, respectively. In the following description, the processing executed by each of the control units 21, 31, and 41 may be executed by the user terminal 20, the worker terminal 30, and the in-vehicle device 40, respectively. The processing executed by the user terminal 20, the worker terminal 30, and the in-vehicle device 40 can be referred to as processing executed by the control units 21, 31, and 41, respectively.

The communication units 22, 32, and 42 include at least one external communication interface connected to the network 50. The communication units 22, 32, and 42 receive data used for operations of the user terminal 20, the worker terminal 30, and the in-vehicle device 40, respectively, and transmit data obtained by operations of the user terminal 20, the worker terminal 30, and the in-vehicle device 40 to the outside.

The storage units 23, 33, and 43 include at least one semiconductor memory, at least one magnetic memory, at least one optical memory, or a combination of at least two types thereof. The storage units 23, 33, and 43 store programs and data used for operations of the user terminal 20, the worker terminal 30, and the in-vehicle device 40, and data obtained by operations of the user terminal 20, the worker terminal 30, and the in-vehicle device 40, respectively. The information stored in the storage units 23, 33, and 43 may be updatable by, for example, information acquired from the network 50 via the communication units 22, 32, and 42, respectively.

The positioning units 24, 34, and 44 include one or more devices that acquire position information of the user terminal 20, the worker terminal 30, and the in-vehicle device 40, respectively. The position of the in-vehicle device 40 is the position of the vehicle 60. The position information preferably has an accuracy of determining a difference that is less than or equal to the dimension of the vehicle. The positioning units 24, 34, and 44 include receivers corresponding to Global Positioning System (GPS), for example, but are not limited thereto, and may include receivers corresponding to any satellite-based positioning system. The positioning units 24, 34, and 44 may constantly acquire the positional information of the user terminal 20, the worker terminal 30, and the in-vehicle device 40, or may periodically or non-periodically acquire the positional information.

The input units 25, 35, 45 include at least one input interface. The input interface is, for example, a touch screen integrally provided with a physical key such as a keyboard, a capacitive key, a pointing device, and a display. The input interface may be, for example, a microphone that receives an audio input and/or a camera that receives an image input. The input units 25, 35, and 45 receive operations for inputting data used for operations of the user terminal 20, the worker terminal 30, and the in-vehicle device 40, respectively. Instead of being provided in the user terminal 20, the worker terminal 30, and the in-vehicle device 40, the input units 25, 35, and 45 may be connected to the user terminal 20, the worker terminal 30, and the in-vehicle device 40 as external input devices, respectively.

Outputs 26, 36, 46 include at least one output interface. The output interface is, for example, a display for outputting information in video, a speaker for outputting information in audio, or the like. The display is, for example, an LCD or an organic EL display. The output units 26, 36, and 46 output data received via the network 50, or data obtained by the operation of the user terminal 20, the worker terminal 30, and the in-vehicle device 40. The output units 26, 36, and 46 may be connected to the user terminal 20, the worker terminal 30, and the in-vehicle device 40 as external output devices, instead of being provided in the user terminal 20, the worker terminal 30, and the in-vehicle device 40, respectively.

In addition to the above-described components, the user terminal 20 may incorporate a camera 27. The camera 27 includes an optical system and an image sensor. The imaging device may include either a Charge-Coupled Device Image Sensor (CCD image sensor) or a Complementary MOS Image Sensor (CMOS image sensor).

### Example of Power Supply to a Vehicle by a Power Supply Vehicle

Next, charging of the vehicle 60 by the power supply vehicle 70 will be described with reference to FIG. 4. First, vehicles 60 are externally chargeable electrified vehicle including battery-powered battery electric vehicle (BEV), plug-in hybrid electric vehicle (PHEV), and the like. The vehicle 60 has a charging port 61. The charging port 61 is a connection portion for externally charging the battery. The charging port 61 includes a charging inlet for connecting a connector of the charging cable 71 from an external charging device. The charging port 61 may be disposed at any position, such as an upper portion of a front grille of the vehicle 60, a front fender, a rear fender, and a rear bumper. In FIG. 4, the charging port 61 is disposed on the upper portion of the front grille.

The power supply vehicle 70 is a vehicle that supplies electric power to the vehicle 60. The power supply vehicle 70 is equipped with a battery that stores electric power to be supplied to the vehicle 60 or a generator that generates electric power. The power supply vehicle 70 supplies electric power to the charging port 61 of the vehicle 60 via the charging cable 71. In order for the power supply vehicle 70 to supply electric power to the vehicle 60, it is necessary that there is sufficient space around the charging port 61 of the vehicle 60, and that there is space for the power supply vehicle 70 to park around the vehicle 60. If there is not enough space around the charging port 61 of the vehicle 60, it becomes difficult to connect the connector at the end of the charging cable 71 to the vehicle 60. If the space in which the power supply vehicle 70 can park is too far from the vehicle 60, the length of the charging cable 71 from the power supply vehicle 70 to the vehicle 60 may be insufficient, and charging may not be possible. As described above, the power supply vehicle 70 may not be able to charge the vehicle 60 due to the surrounding environment of the vehicle 60.

### An Example of a Surrounding Environment of a Vehicle

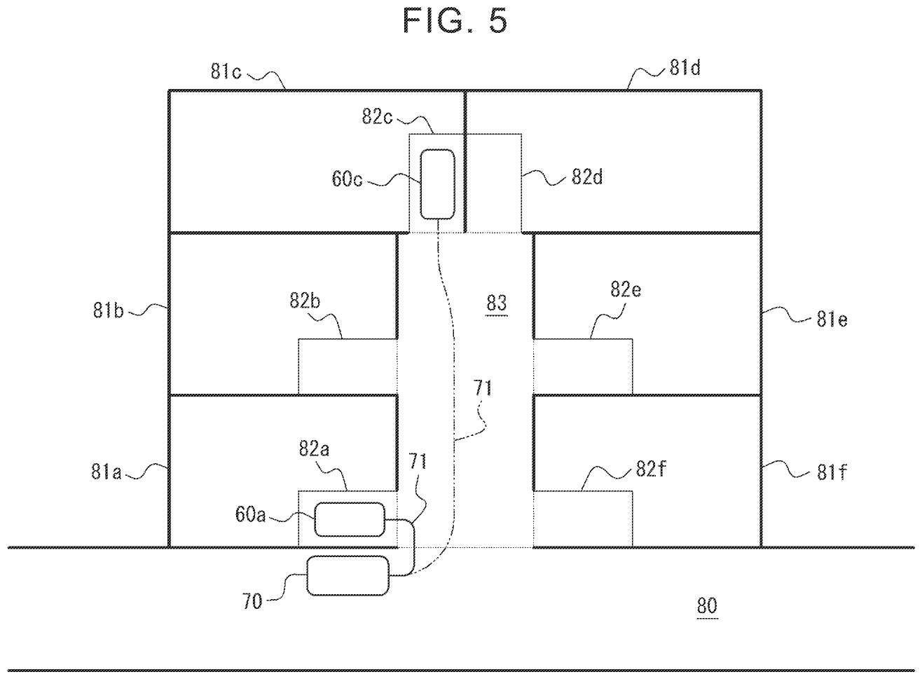

FIG. 5 shows the arrangement of the parking lot 82a to 82f of the dwelling assumed for the purpose of illustration. In the exemplary embodiment of FIG. 5, a site 81a to 81f of six dwellings is arranged in a clockwise direction on a site facing the road 80. The site 81a and 81f face the road 80. The site 81b to 81e is not directly facing the road 80, but is arranged to surround the private road 83 connected to the road 80. The private road 83 shall be shared by the owners of the six residences. Each site 81a to 81f has a parking lot 82a to 82f on the private road 83. The parking lot 82a and 82f also face the road 80.

In such cases, the power supply vehicle 70 can park on the road 80 and easily supply electric power to the vehicle 60a parked on the parking lot 82a facing the road 80. On the other hand, the power supply vehicle 70 may not be able to easily charge the vehicle 60c parked in the parking lot 82 located in the back of the private road 83. For example, the private road 83 may not be allowed to be parked by the power supply vehicle 70 in order for the vehicle parking in the parking lot 82a to 82f to pass through. When the power supply vehicle 70 is parked on the road 80 while avoiding the private road 83, the distance to the vehicle 60c parked in the parking lot 82c may be too far, and the length of the charging cable 71 may be insufficient. In addition, applicable embodiment of the present disclosure is not limited to the case illustrated in FIG. 5, and if parking on the road 80 is prohibited, the vehicle 60 parked in the parking lot 82 facing the road 80 may not be charged.

Further, in a case where a parking lot in which a large number of parking spaces laid in the apartment house are gathered is assumed, there is a case where there is no space around the parking space of the user in which the power supply vehicle 70 can park.

Therefore, it is preferable that the provider providing the charging service can estimate in advance whether the vehicle requesting charging is in a chargeable state.

### Method for Determining the Possibility of Charging

Hereinafter, a method of determining in advance whether or not the power supply vehicle 70 can charge the vehicle 60 will be described with reference to the flowchart of FIG. 6. The method disclosed in this specification can be executed by a processor included in the control unit 11 of the determination device 10 according to a program. Such a program can be stored in a non-transitory computer-readable medium. Non-transitory computer-readable media include, but are not limited to, hard disks, Random Access Memory (RAM), Read Only Memory (ROM), flash memories, Compact Disc Read only memory (CDROM), optical storage devices, magnetic storage devices, and the like.

First, the user operates the user terminal 20 to activate an application for the system 1, and transmits a request for receiving a charging service to a vehicle owned by the user to the determination device 10. Accordingly, the determination device 10 receives the charge request data from the user terminal 20 (S101).

The determination device 10 acquires the charging place from the charging request data acquired from the user terminal 20 (S102). The user can set the charging place to a pre-registered location, a parking lot of a specific facility, or the like.

The determination device 10 searches for charging result information stored in the storage unit 13 according to the charging place acquired by S102 (S103). As a result, when charging is to be performed in the same place in the past, information indicating whether charging has been performed or not is obtained.

If the search for S103 shows that the power supply vehicle 70 has charged at the same charging place in the past (S104: Yes), S105 proceeds. If the power supply vehicle 70 does not have a track record of charging the vehicle 60 at the same charging place in the past (S104: No), S109 proceeds. Note that, although not shown in FIG. 6, if S103 shows that there is no previous request for charging at the same charging place or a record of charging, the process may proceed to S108 instead of S109.

In S105, the determination device 10 determines an overall evaluation value of the degree of difficulty in charging the charging place specified by the user (S105). The determination device 10 extracts the number of times the charging of the charging place designated by the user and the number of times the charging cannot be performed from the result of the search for the charging result information in S103. In addition, the determination device 10 acquires the degree of difficulty in a case where charging is performed. For example, in FIG. 2, the degree of difficulty is represented by a time taken from when the power supply vehicle 70 arrives at the location of the vehicle 60 to when the charging of the vehicle 60 starts.

In one embodiment, the difficulty may be replaced by an individual evaluation value. For example, when the time from when the power supply vehicle 70 arrives at the location of the vehicle 60 until when the charging of the vehicle 60 is started is 0 minutes to 10 minutes, 10 minutes to 20 minutes, 20 minutes to 30 minutes, and 30 minutes or more, the difficulties may be 0, 1, 2, and 3, respectively. In addition, it is possible to set the degree of difficulty in the case where the charging cannot be performed to 5.

The determination device 10 determines an individual evaluation value of the degree of difficulty on the basis of a time taken from when the power supply vehicle 70 arrives at the vehicle 60 until when the charging of the vehicle 60 is started, or a time from when the power supply vehicle completes the charging of the vehicle until when the power supply vehicle leaves the location of the vehicle, for each request for charging received in the past. The determination device 10 may average the individual evaluation values of the degree of difficulty in charging the vehicle 60 at the past charging place to obtain an overall evaluation value of the degree of difficulty.

Subsequently, the determination device 10 determines a possibility that the vehicle 60 can be charged at the charging place requested to be charged (S106). For example, the determination device 10 can evaluate the possibility of charging based on the rate at which charging was possible, while the charging was requested in the same place in the past. For example, it can be determined that the possibility of charging is high when the rate of charging is 50% or more. Further, for example, the determination device 10 may determine the possibility of charging based on the overall evaluation value of the difficulty level. For example, when the overall evaluation value of the degree of difficulty quantified as described above is less than 3, it may be determined that the possibility of charging is high.

In addition, the determination device 10 may evaluate the possibility of charging at the charging place in consideration of information such as time and day of the week. For example, the determination device 10 obtains the correlation between the information on the time and/or the day of the week included in the charging result information and the information on whether or not charging has been performed. For example, when there is a high correlation between the time information and the information on whether or not charging has been performed, the determination device 10 may determine the possibility of charging based on the time at which charging is scheduled. In this case, the determination device 10 may calculate an overall evaluation value of the degree of difficulty for each time and/or day of the week.

When it is determined that there is a high possibility of charging by S106 (S107: Yes), the determination device 10 arranges the power supply vehicle 70 for charging the vehicle 60 (S108). More specifically, in order to charge the vehicle 60, the determination device 10 includes a schedule of charging the vehicle 60 in a schedule of one power supply vehicle 70. Further, the determination device 10 determines a worker riding on the power supply vehicle 70, and transmits a charge service provision schedule including a charge schedule for the vehicle 60 to the worker terminal 30 of the worker.

On the other hand, when there is no record of previous charging at the requested charging place in S104 (S104: No), and when it is determined in S107 that there is no high possibility that the vehicle 60 can be charged (S107: No), the determination device 10 transmits a message requesting the user terminal 20 to transmit images around the charging place (S109).

When the user terminal 20 receives the message requesting the transmission of the surrounding image, it displays the message on the display of the output unit 26. The user who views the displayed message captures an image of the vicinity of the charging place including the vehicle 60 using the camera 27 built in the user terminal 20. The determination device 10 may display a message requesting the user terminal 20 to acquire an image from a specific direction. For example, the determination device 10 may cause the user terminal 20 to display a message requesting acquisition of an image obtained by capturing the periphery of the charging port 61 from the right side. The number of images requested by the determination device 10 may be two or more. The captured image is transmitted to the determination device 10 via the communication unit 22. As a result, the determination device 10 can acquire peripheral images captured by the user (S110).

The determination device 10 determines whether or not the vehicle 60 can be charged based on the acquired surrounding images of the parking locations (S111). For example, when the determination device 10 determines that there is a space for connecting the charging cable 71 to the vehicle 60 and a space for parking the power supply vehicle 70 in the vicinity of the vehicle 60 through the imaging process, the determination device determines that charging is possible (S111: Yes). In this situation, the determination device 10 proceeds to S108 and arranges the power supply vehicle 70 to charge the vehicle 60. The determination of S111 may be performed by a human viewing images displayed on a display that is an output unit of the determination device 10. The determination result may be input to an input unit of the determination device 10 and used as a determination result of the determination device 10.

On the other hand, when determining that the vehicle 60 is not chargeable based on the images acquired by S111 (S111: No), the determination device 10 notifies the user terminal 20 that charging cannot be performed. The user terminal 20 displays the notification received from the determination device 10 on a display which is an output unit 26.

In the flowchart of FIG. 6, S111 from S109 may not be executed. When there is no record of charging in S104 in the past (S104: No) and when it is determined that there is a low possibility of charging in S107 (S107: No), the determination device 10 may directly notify the user terminal 20 that charging cannot be performed (S112).

As described above, according to the present embodiment, the determination device 10 can retrieve the charging result information based on the charging place information of the vehicle 60 included in the charging request information, and can determine in advance the possibility of charging at the charging place. As a result, the power supply vehicle 70 dispatched to the charging place according to the request from the user cannot charge the vehicle 60, and thus the possibility of occurrence of opportunity loss can be reduced.

Further, the charging result information includes an individual evaluation value indicating a degree of difficulty in a case where charging is performed, and the determination device 10 determines an overall evaluation value for the charging place based on the plurality of individual evaluation values. As a result, the determination device 10 can reflect the result of dispatching the power supply vehicle 70 a plurality of times in the past to the same charging place in the determination of whether or not charging is possible. Further, the determination device 10 determines the individual evaluation value based on the time taken from when the power supply vehicle 70 arrives at the vehicle 60 to when the charging of the vehicle 60 is started, and/or the time from when the power supply vehicle 70 completes the charging of the vehicle 60 to when the vehicle 60 leaves the place. This makes it possible to objectively determine the degree of difficulty by using time information that is relatively easy to acquire.

Further, since the determination device 10 can transmit a message requesting the user terminal 20 to transmit an image around the charging place, it can determine the possibility of further charging based on the image. As a result, there is a high possibility that the charging service can be provided even in the vehicle 60 parked in a place where the charging service cannot be provided only from past information. Therefore, an opportunity to provide a charging service is increased for a business operator that provides the charging service. In addition, the user is more likely to be able to use the charging service.

In addition, based on the past information, the determination device 10 can determine the possibility that charging can be performed at the charging place in consideration of the time and day of the week information, so that the accuracy of determining whether or not the power supply vehicle 70 can be charged to the vehicle 60 is improved.

An applicable embodiment of the present disclosure is not limited to the above embodiment, and many modifications or alternations can be made. For example, the functions included in each means, each step, etc. can be rearranged so as not to be logically inconsistent, and a plurality of means, steps, etc. can be combined into one or divided.

In the embodiment illustrated in FIG. 5, the vehicles 60 charge 82f as the charging place from the parking lot 82a in 81f from the personal site 81a. However, the charging place may be a parking lot used by a plurality of vehicles attached to a public facility, a commercial facility, or the like. Even in this case, the determination device 10 can collect information indicating whether charging is possible. In the case of a parking lot attached to such a facility, whether or not the power supply vehicle 70 is inserted into the parking facility may be a problem as the charging possibility information. When the power supply vehicle 70 does not enter the parking lot due to a size limitation or the like, power cannot be supplied to the vehicle 60. In addition, even when the vehicle is placed in the parking lot, whether or not the power supply vehicle 70 can be charged depends on whether or not it can be parked in the vicinity of the vehicle 60 to be charged. In a time period in which the entire parking lot is congested, the possibility that the power supply vehicle 70 can charge the vehicle 60 is reduced. On the other hand, if the entire parking lot is in a chair time zone, there is a high possibility that charging can be performed using the parking lot attached to such a facility. Since the determination device 10 can determine the possibility of charging at the charging place in consideration of the time and day of the week information, it is also effective to provide the charging service using the parking lot of such a facility.

What is claimed is:

1. A determination device configured to, in a charging service for charging a vehicle of a user by dispatching a power supply vehicle in response to a request from the user, make determination on a possibility of charging the vehicle of the user based on the request, the determination device comprising:
a storage unit configured to store a plurality of pieces of charging result information including a set of charging place information included in a request received in a past and indicating a charging place and charging possibility information indicating whether a vehicle has been charged at the charging place;
a communication unit configured to communicate with a user terminal carried by the user and receive the request from the user; and
a control unit configured to search for the charging result information based on charging place information of the vehicle included in the request, acquire the charging possibility information at the charging place, and make determination on the possibility of charging at the charging place based on the acquired charging possibility information.

2. The determination device according to claim 1, wherein:
the charging result information further includes an individual evaluation value of a degree of difficulty in charging when charging is possible; and
the control unit is configured to, when evaluation is made that the charging is possible, determine an overall evaluation value of the degree of difficulty for the charging place based on the individual evaluation value of the degree of difficulty.

3. The determination device according to claim 2, wherein the individual evaluation value of the degree of difficulty is determined for each request for the charging received in the past based on a period from arrival of the power supply vehicle at the vehicle to start of the charging of the vehicle, or a period from completion of the charging of the vehicle by the power supply vehicle to leaving from a location of the vehicle.

4. The determination device according to claim 1, wherein the control unit is configured to, when determination is made that the possibility of charging at the charging place is low, transmit, via the communication unit, a message for requesting the user terminal to transmit an image of a periphery of the charging place.

5. The determination device according to claim 1, wherein:
the charging result information includes information on a time and a day of a week when charging was attempted in response to the request received in the past; and
the control unit is configured to make determination on the possibility of charging at the charging place in consideration of the information on the time and the day of the week.
